(19) United States
(12) Patent Application Publication
(10) Pub. No.: US 2001/0044788 A1
(43) Pub. Date: Nov. 22, 2001

(54) Dynamic-risk pricing for air-charter services

(75) Inventors: Ramazan Demir, Cambridge, MA (US); David E. McCown, San Francisco, CA (US); Robert H. McBride, Concord, MA (US); Fatih Usta, Watertown, MA (US); John W. Scott, San Francisco, CA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: FlightTime Corporation

(21) Appl. No.: 09/803,962

(22) Filed: Mar. 12, 2001

Related U.S. Application Data
(60) Provisional application No. 60/188,563, filed on Mar. 10, 2000.

(51) Int. Cl. G06F 17/00

(52) U.S. Cl. 705/400; 705/418

(57) ABSTRACT

The invention provides a system and method for dynamically pricing charter air charter services. The invention receives information regarding a traveler's itinerary, develops a demand forecast, matches the demand and dynamically adjusts pricing based upon the received information. The invention also provides a series of methodologies that minimize flight costs through efficient excess capacity allocation, demand modeling, forecasting and matching techniques.

### CROSS REFERENCE TO RELATED APPLICATIONS

This application claims priority from U.S. Provisional Pat. application Ser. No. 60/188,563, entitled, MATCHING CHARTER CAPACITY WITH SUITABLE ITINERARIES VIA THE INTERNET, filed on Mar. 10, 2000, the entirety of which is herein incorporated by reference.

### BACKGROUND OF THE INVENTION

1. Field of the Invention

The invention relates to a system and method for dynamically determining prices based upon demand requirements. More particularly, the invention provides a system and method for dynamic and probabilistic pricing of air charter services based upon demand modeling and forecasting that efficiently allocates excess capacity.

2. Discussion of the Related Art

In recent years, the use of charter aircraft by corporations and individual citizens has increased significantly, making it one of the fastest growing methods of transportation. Charter aircraft offer many advantages over commercial airlines, including privacy, flexibility in departure times and flexibility in destinations that may be reached. Thus, charter aircraft do not experience the most common problems associated with commercial aircraft, including a lack of scheduled commercial airline availability for desired destinations and/or times, and undesirable layovers.

Charter flights are typically booked through brokerage companies that match trip (i.e., itinerary) requirements with available aircraft supply. Charter airline operators typically provide the supply of aircraft and are generally certified to own and operate aircraft. Airline operators typically charge a base price for use of an aircraft that is not necessarily related to the number of passengers, but instead is dependent upon the type of aircraft requested, total flight hours, the destination and other operational and incidental costs. Brokerage companies apply a commission rate to the base cost in order to set the price of the charter service. This pricing scheme can be considered as the mark-up rule.

Unfortunately, existing charter flight booking methodologies have two significant inefficiencies: there are often unused seats that could be rented out to other individuals desiring the same destination and travel times; and typical trips often result in an empty and positioning aircraft returning to the base of operations. Thus, the existing charter flight booking methodologies are unable to offer unused seats for sale and do not coordinate the flight times and destinations of the entire aircraft fleet allowing return flights to be filled.

Existing charter flight booking and pricing methodologies may be described in further detail using the following notations and definitions:

Let L={A₁, A₂, . . . } be a listing of available airports.

A typical itinerary for an-air-charter flight includes a set of airports where aircraft have certain arrival times which captures a passenger's flight schedule.

Further, let α=1, 2, 3 . . . represent the type of aircraft, for example, small, medium or large;

Let ti(x) be the arrival time of the aircraft at the airport x for the i-th time in itinerary;

An itinerary I in a certain type of aircraft a can be represented as an ordered set:

I^{α}={(A₁,t₁(A₁)),(A₂,t₁(A₂)), . . . , (A₁,t₂(A₁)) . . . (Aₙ,tᵣ(Aₙ))}

Where Aᵢ, i=1 to n denotes the airports to be visited according to the specified arrival times t.(.).

For example, (A₁,t₂(A₁)) denotes the second visit to an airport A₁ at time t₂(A₁).

Typically, an aircraft is positioned from a base to the origin of the itinerary. In this case, let Pₓ be the positioning airports for the airport x∈L. Let N_{δ}(x)={l∈L|d(x,l)≦δ} denote the neighbor airports of the airport x for a specified parameter δ and d(.,.) distance metric. The flight cost of a type a aircraft from airport Aₖ to Aₗ may be represented by c^{α}(Aₖ,Aₗ). Further, the waiting cost for aircraft α at an airport Aₖ for a given time t may be represented by C^{α}w(Aₖ,t). The waiting cost represents the opportunity cost for the operator of the charter aircraft not having allocated the aircraft to another itinerary. This cost typically includes operational expenses and minimal aircraft flight-hour requirements. Let c(I^{a}) represent the total flight cost of an itinerary that includes the flight and waiting costs.

When determining the price of a charter flight, conventional booking organizations apply mark-up pricing rules based upon a base cost provided by an operator. Assuming that a traveler K wants a one way trip from Boston (BOS) to San Francisco (SFO) beginning at 10:00 a.m. on Jan. 1, 2001 on a medium sized aircraft, i.e., α=2. FIG. 1 shows a flight pattern for this one-way itinerary. The itinerary may be represented by:

I^{a}_{K}={(Aₜ,tₜ(A₁)),(A₂t₁(A₂))},

and

I²_{K}={(BOS,t₁(BOS),(SFO,t₁(SFO))}

The base cost of this itinerary may be represented by:

c_{T}=c(I^{α}K)=c²(P_{BOS},BOS)+c²(BOS,SFO)+c³(SFO,P_{BOS})

The air charter company then marks up the base cost and charges the traveler c_{T}(1+r) where r is the commission rate. The traveler is, thus, charged with the return flight (an empty flight) that represents 50% of the total charter cost.

Similarly, travelers booking round trip charter flights also incur extra charges not related to the actual utilization of the aircraft for a particular flight. These extra charges may include the cost of having the aircraft wait for the return flight leg, positioning the flight legs from the base airports and empty flight legs associated with routing an aircraft to handle the live leg portion of the trip.

For example, if a traveler K books a round-trip itinerary between Boston (BOS) and San Francisco (SFO) on a large aircraft, let the first live leg begin at 10:00 a.m. on Feb. 22, 2001, i.e., A₁=BOS and A₂=SFO with arrival times t₁(A₁)=(10:00, 2-22-2001) and t₁(A₂)=(14:50, 2-22-2001) (based upon the average flight time from Boston to San Francisco). If the second live return leg starts at 2:00 p.m. on Feb. 25, 2001, then t₂(A₁)=(23:53, 2-25-2001) and t₂(A₂)=(14:00, 2-25-2001). Thus the itinerary for client K may be represented as:

I^{a}_{K}={(A₁,t₁A₁)),(A₂,t₁(A₂),(A₂,t₂(A₂)), (A₁,t₂(A₁))},

and

I³_{K}={(BOS, t₁(BOS),(SFO,t₁(SFO)),(SFO,t₂(SFO)),(BOS,t₂(BOS))}

The aircraft operators can fulfill this type of trip request in two alternative manners, depending upon the cost analysis: the immediate return to base plan, and the stay at destination plan.

FIG. 2 illustrates the immediate return to base plan. As shown in FIG. 2, the first portion of the trip entails a positioning leg 210 that requires the aircraft travel from its base of operations P_{BOS} to a starting point of the trip, in this case Boston (BOS). The next leg of the trip is the actual flight (live leg) 220 that carries the traveler from Boston to San Francisco. Once the aircraft reaches its destination, it flies an empty leg 230 back to the base P_{BOS}.

According to the itinerary schedule (I²ₖ), the aircraft is positioned from its base P_{BOS} to SFO, the origin of the second portion of the trip, that creates the positioning leg 250. The aircraft then carries the travelers on the flight 260 to Boston. Once the travelers have reached their final destination, BOS, the aircraft flies a positioning leg 270 to return to its base of operations P_{BOS}.

The flight cost via an intermediate return base plan is c_{T}(immediate−return−base)=c³(P_{BOS}, BOS)+c³(BOS,SFO)+C³(SFO,P_{BOS})+C³(P_{BOS}, SFO)+c³(SFO, BOS)+c³(BOS,P_{BOS}). In the first portion of the trip, C³(P_{BOS}, BOS) denotes the flight cost of positioning leg 210. c³(BOS,SFO) denotes the flight cost of live leg 220 and c³(SFO,P_{BOS}) denotes the flight cost of empty leg 230. Similarly, in the return portion of the trip, c³(P_{BOS}, SFO) denotes the flight cost of the positioning leg 250, c³(SFO, BOS) denotes the flight cost of the live leg 260 and c³(BOS,P_{BOS}) denotes the flight cost of the empty leg 270. The aircraft flies a total of four legs, positioning legs 210 and 250 and empty legs 230 and 270, typically without any passenger on board. In contrast, only two legs 220 and 260 actually carry passengers. Since the traveler pays for the cost of the positioning and empty legs, these non-passenger bearing flight segments significantly add to the total flight cost.

FIG. 3 illustrates a stay case at the destination airport as described below. As shown in FIG. 3, the first portion of the trip is the positioning leg 310, requiring that the aircraft travel from its base of operations P_{BOS} to the starting point of the trip, in this case Boston (BOS). The next leg of the trip is the actual flight (live leg) 320 carrying travelers from Boston (BOS) to San Francisco (SFO). Once the aircraft reaches its destination, it remains in SFO until time for the return flight arrives, as shown by waiting leg 330. The aircraft then carries the travelers on the flight 340 to Boston. Once the travelers have reached their final destination, in this case Boston, the aircraft flies a positioning leg 350 to return to its base of operations P_{BOS}. The cost of the stay at destination plan may be expressed as follows: c_{T}(stay)=c³(P_{BOS}, BOS)+c³(BOS, SFO)+c³w(SFO, t₂(SFO)−t₁(SFO))+c³(SFO, BOS)+c³(BOS,P_{BOS}).

In the first portion of the trip, c³(P_{BOS}, BOS) denotes the flight cost of the positioning leg 310, c³(BOS, SFO) denotes the flight cost of the live leg 320. c³w (SFO,t₂(SFO)−t₁(SFO)) denotes the waiting cost (leg 330) of a large aircraft at SFO for an additional time of t₂(SFO)−t₁(SFO) because the aircraft is scheduled to leave SFO at a time t₂(SFO) for its return flight after arriving there at t₁(SFO). Similarly, in the return portion of the trip, c³(SFO, BOS) denotes the flight cost of live leg 340 and c³(BOS,P_{BOS}) denotes the flight cost of empty leg 350. The aircraft flies a total of two legs, positioning legs 310 and 340, typically without any passengers on board. It also waits at the airport creating waiting leg 330. In contrast, only two legs, 320 and 340 actually carry passengers. Since traveler K is liable to pay positioning and waiting legs, these non-passenger bearing flight and waiting segments drive up the total flight cost significantly.

Under the conventional pricing approach, operators typically compare c_{T}(intermediate−return−base) and c_{T}(stay) to determine a final flight cost for the associated trip request.

Thus, as illustrated above, conventional air charter pricing mechanisms pass significant logistical costs onto travelers, such as the cost of positioning the aircraft, the cost for the aircraft to wait for a return flight and the cost for travelling without passengers (empty legs). There is no methodology employed to predict demand efficiently and utilize excess capacity (the empty and positioning legs) that are typically created after a trip is booked. Further, the conventional mark-up rule pricing does not consider demand and aircraft movements within a charter aircraft fleet.

Conventional air charter pricing methodologies also do not employ probabilistic pricing that utilizes demand forecasting and dynamic aircraft movement information. In addition, conventional pricing methodologies do not provide air charter pricing in a passenger bundle and do not provide a cancellation policy in conjunction with dynamic risk pricing.

### SUMMARY OF THE INVENTION

The invention provides a system and method that overcomes the deficiencies in conventional aircraft charter booking methodologies as described above. The invention thus provides a system and method for dynamically pricing aircraft charter services based upon several factors, including the type of aircraft, the trip itinerary and the destination.

The invention further provides a framework and series of methodologies that provide an integrated decision supporting system that dynamically sets prices to air charter services and its by products.

Therefore, it is an object of the invention to provide a system for dynamically pricing air charter services that includes a programmed computer, a storage device, a demand forecasting module, a demand matching module and an intelligent pricing module.

It is another object of the invention to provide a method for dynamically pricing air charter services that includes the steps of receiving trip request information, determining a maximal time allowance, forecasting demand based upon the demand modules, matching demand based upon the received trip request information, determining a price discount and outputting the adjusted sale price based upon the price discount with a cancellation policy directly associated with the price discount.

According to one embodiment, the invention provides for system integration of a booking system with an intelligent pricing module. This integration provides a seamless information transfer between a booking engine and a pricing module.

The invention further provides a system and method for demand modeling that collects and stores trip information data to apply time-series modeling techniques to analyze demand patterns. Different demand types are introduced depending on the context of the application.

The invention further provides a demand modeling methodology that includes the steps of retrieving historical demand information, specifying a time series model, estimating the parameters and conducting a diagnostic check of whether the original specification was correct or not.

It is another object of the invention to provide a system and method for demand forecasting. Once a demand class has been specified, the system according to an embodiment of the invention retrieves relevant information from a historical demand database and applies a demand model in order to predict future demand values.

It is a further object of the invention to a system and method that allows unrelated travelers to share an aircraft based upon their demand patterns. The traveler's demand patterns are captured through demand modeling and demand forecasting modules.

It is another object of the invention to provide a cancellation methodology that complements the dynamic risk pricing system and method according to the invention.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention described herein also incorporates by reference the subject matter of co-pending U.S. Pat. application Ser. No. 09/627,646, filed on Jul. 28, 2000 and co-pending U.S. application Ser. No. 09/585,818, filed Jun. 1, 2000.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a diagram illustrating the logistics of a one-way trip air charter flight;

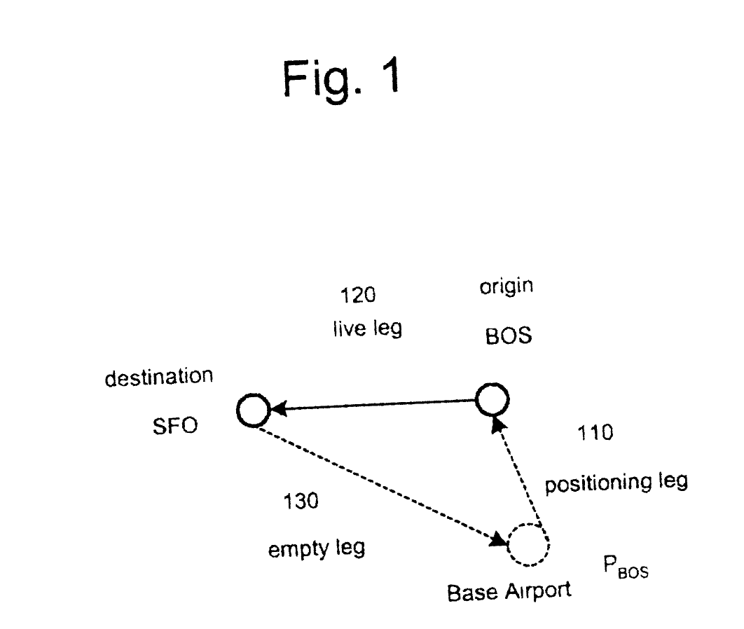

FIG. 2 is a diagram illustrating an immediate return to base flight plan;

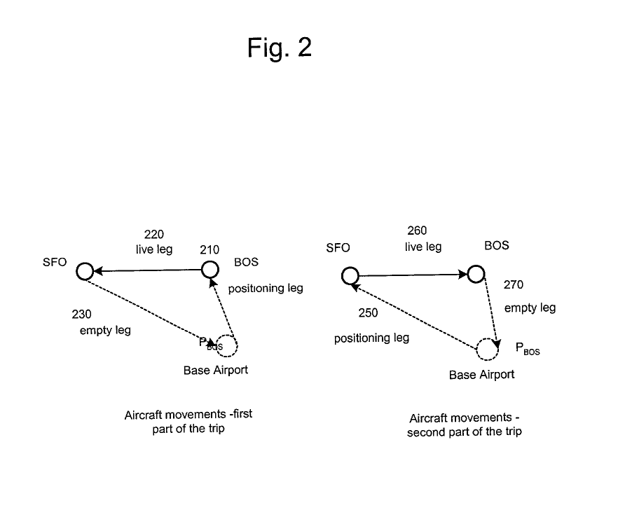

FIG. 3 is a diagram illustrating the stay at destination flight plan;

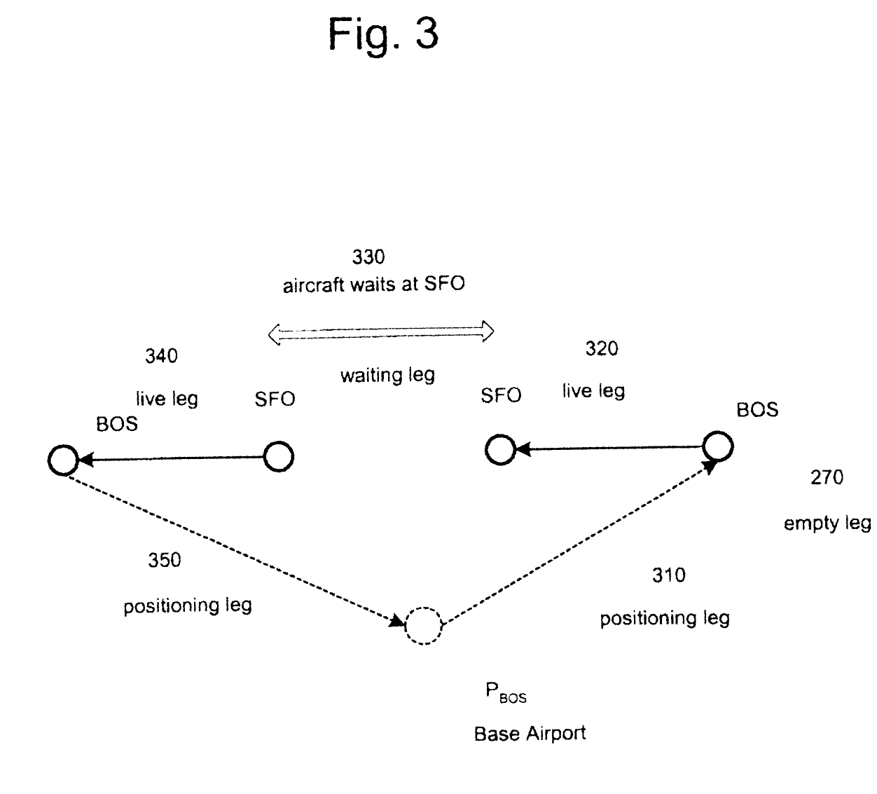

FIG. 4 is a block diagram illustrating the dynamic pricing system according to an embodiment of the invention coupled with a booking engine;

FIG. 5 is block diagram illustrating the demand forecasting module in greater detail;

FIG. 6 is diagram illustrating a travel pattern for two travelers.;

FIG. 7 is a time representation diagram illustrating a travel pattern for two travelers;

FIG. 8 is a diagram illustrating a combined itinerary;

FIG. 9 is a flowchart illustrating the process for dynamically pricing air charter services in accordance with an embodiment of the invention;

FIG. 10 is a flowchart illustrating the demand forecasting process; and

FIG. 11 is a flowchart illustrating the demand matching process.

### DETAILED DESCRIPTION OF THE PREFERRED EMBODIMENTS

Reference will now be made in detail to the preferred embodiment of the invention, examples of which are illustrated in the accompanying drawings.

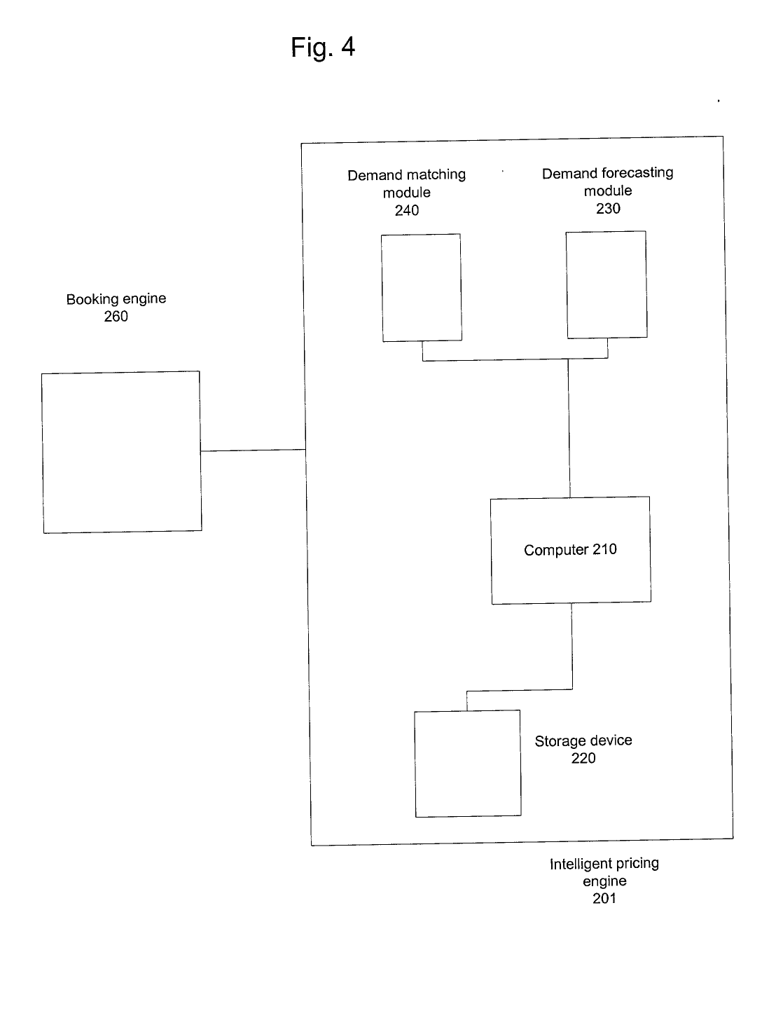

FIG. 4 shows a block diagram of the dynamic pricing system integrated with a booking system according to an embodiment of the invention. FIG. 4 shows an intelligent pricing engine 201 that dynamically prices air charter services based upon demand matching and forecasting. The intelligent pricing engine 201 is a decision support system that enables automatically setting prices before fulfilling a trip. The intelligent pricing engine 201 includes a computer 210 coupled to a storage device 220, a demand forecasting module 230 and a demand matching module 240. A booking engine is coupled to the intelligent pricing engine 201 and receives trip requests through various channels from customers.

According to one embodiment of the invention, storage device 220 holds trip request information, including origin information, destination information, aircraft type information and time schedule information. The origin information refers to the origin or starting point of the flight. The destination information refers to the traveler's destination. The aircraft type information refers to the type of aircraft that a traveler desires (i.e., twin engine 4-seater; 10 seater jet, etc.). The time schedule refers to the desired departure times for each leg of the journey.

While the intelligent pricing engine 201 as shown in FIG. 4 includes the demand forecasting module 230 and the demand matching module 240, it is important to note that these modules may also be configured as stand alone entities. Thus, the demand forecasting module 230 and the demand matching module 240 may be free standing components coupled to the intelligent pricing engine 201.

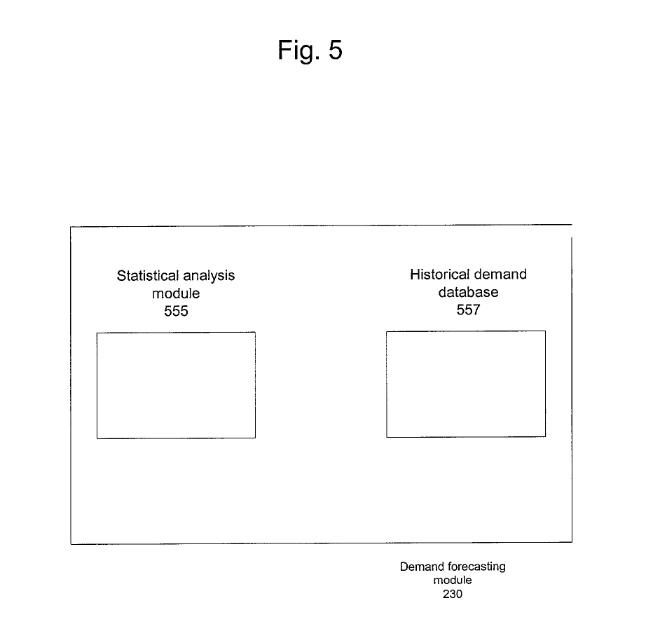

FIG. 5 shows the demand forecasting module 230 in greater detail. As shown in FIG. 5, the demand forecasting module 230 includes a statistical analysis component 555 and a historical demand database 557.

Prior to describing the processes according to embodiments of the invention, the following description is provided to introduce notations, definitions and concepts.

As an example, a traveler 1 books a trip at a time t₁ from point A to B starting at t₁(A). Further, assume that a traveler 1 selects a medium sized aircraft, i.e., α=2, I^{α}₁={(A,t₁(A)),(B,t₁(B))}. A traveler 2 books a trip at time t₂∈(t₁(B),t₁(X)) from X∈N_{δ}(B) to Y∈N_{δ}(A), i.e., I^{α}₂={(X,t₁(X)),(Yt₁(Y))} on an un-dominating aircraft compared to traveler 1's choice of aircraft. An un-dominating aircraft is an aircraft whose size is smaller than or equal in size to the aircraft selected by traveler 1. For this example, an un-dominating aircraft for traveler 2 is a small or medium aircraft because traveler 1 has chosen a medium sized aircraft.

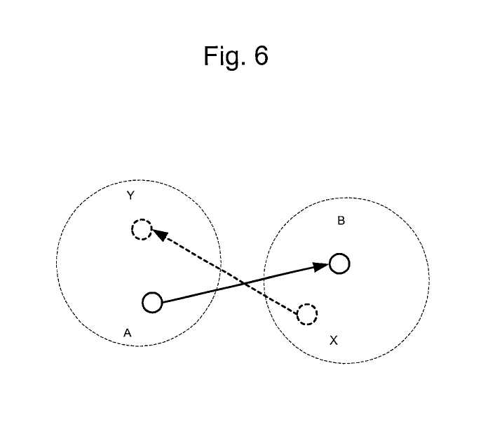

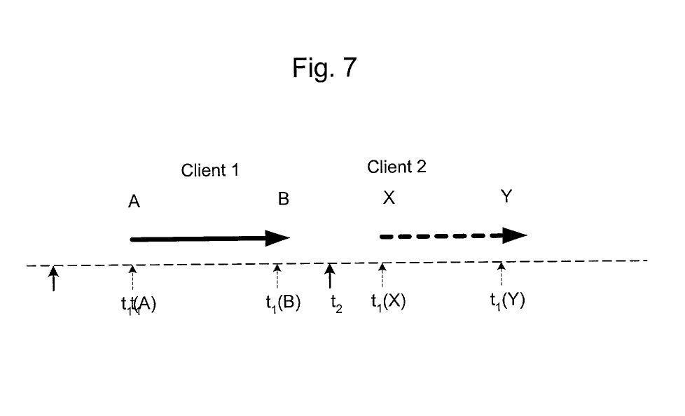

Let c(I^{α}₁), c(I^{α}₂) denote the flight cost for trip 1 and 2, respectively. Thus, c(I^{α}₁)=c^{α}(P_{A},A)+c^{a}(A,B)+c^{α}(B,P_{A}) and c(I^{αa}₂)=c^{α}(P_{X},X)+c^{α}(X, Y)+c^{α}(Y,P_{X}). Thus, a brokerage company charges c(I^{α}₁)(1+r) and c(I^{α}₂)(1+r) to travelers 1 and 2, respectively (assuming that the same r is applied). Let c_{T}=c(I^{α}₁)+c(I^{α}₂) be the overall cost for these two trips. Thus, the brokerage company charges c_{T}(1+r) to the travelers once it fulfills these trips while transferring c_{T} to the operators. This example is illustrated in FIGS. 6 and 7.

As shown in the example above, travelers 2's trip is almost a return trip due to its origin and destination pair being in the neighborhood of B and A, respectively and due to the selection of an un-dominating aircraft. Thus, as is demonstrated by this example, significant efficiencies may be achieved if the charter aircraft fleet can take advantage of each aircraft's fight schedule.

A total cost under the assumption that the aircraft that served traveler 1 will serve traveler 2 may be calculated as follows. This determination implicitly assumes that the aircraft stays at a location B from time t₁(B) to t₁(X). The new schedule can be seen as a combined itinerary:

I^{α}_{c}={(A,t₁(A)),(B,t₁(B)),(X,t₁(X)),(Y,t₁(Y))}

A waiting schedule can be represented as follows:

W(I)={(A₁,Δ₁A₁)),(A₂,Δ₁(A₂)), . . . ,(A_{K},Δ₁(A_{K}))}

The waiting schedule above is associated with an itinerary I, meaning that the aircraft waits at the airport A₁ for a Δ₁(A₁) time, at A₂ for Δ₁(A₂) time and so on. Thus, the total cost becomes:

c_{T}=c(I^{α}_{c}, W(I^{α}_{c}))=c^{α}(P_{A},A)+c^{α}(A,B)+c^{α}w(B,t₁(X)−t₁(B))+c^{α}(B,X)+c^{α}(X,Y)+c^{α}(Y,P_{A}),

where:

W(I^{α}_{c})={(B,Δ₁(B))} and Δ₁(B)=t₁(X)−t₁(B).

Thus, if a brokerage company observes both traveler 1 and 2's trip requests and c_{T′}<c_{T}, the brokerage company can form a relationship with the operator by forcing the aircraft to stay at B for Δ₁(B) to achieve a savings of c_{T}−c_{T′}. The invention provides the methodology and system to predict whether traveler 2 will request a trip at a time t₁(X)=t₁(B)+Δ for a Δ time that ensures that c_{T′}<c_{T}, i.e., the combined itinerary flight cost is less than the total flight cost of both trips A to B and X to Y. The brokerage company may, thus, force the aircraft to stay at position B for a time A to realize the cost savings c_{T}−c_{T′}.

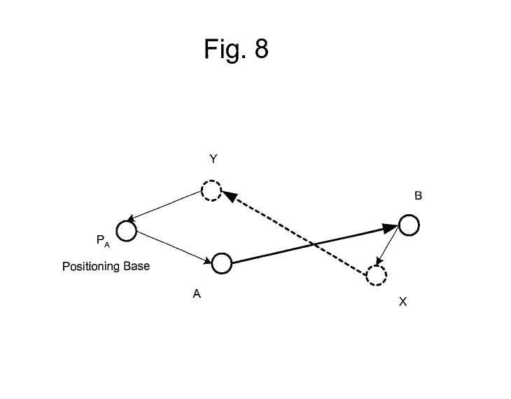

The demand forecasting module 230 according to the invention predicts aircraft flight patterns and, thus, facilitates the cost savings described above. FIG. 8 is a diagram illustrating the combined flight itinerary described above. FIG. 8 shows two flight itineraries, A to B and X to Y. In this example, the aircraft is based in a positioning base P_{A}. The aircraft then moves to position A where it carries a first group of passengers to position B. Then based upon the demand forecasting module 230 according to the invention, the aircraft moves to position X in anticipation of another flight. The aircraft picks up passenger at position X for a journey to position Y. Once the passengers are dropped off in position X, the aircraft returns to its origin, or positioning base PA. As illustrated in FIG. 8, the demand forecasting module 230 reduces the number of miles that the aircraft travels without passengers.

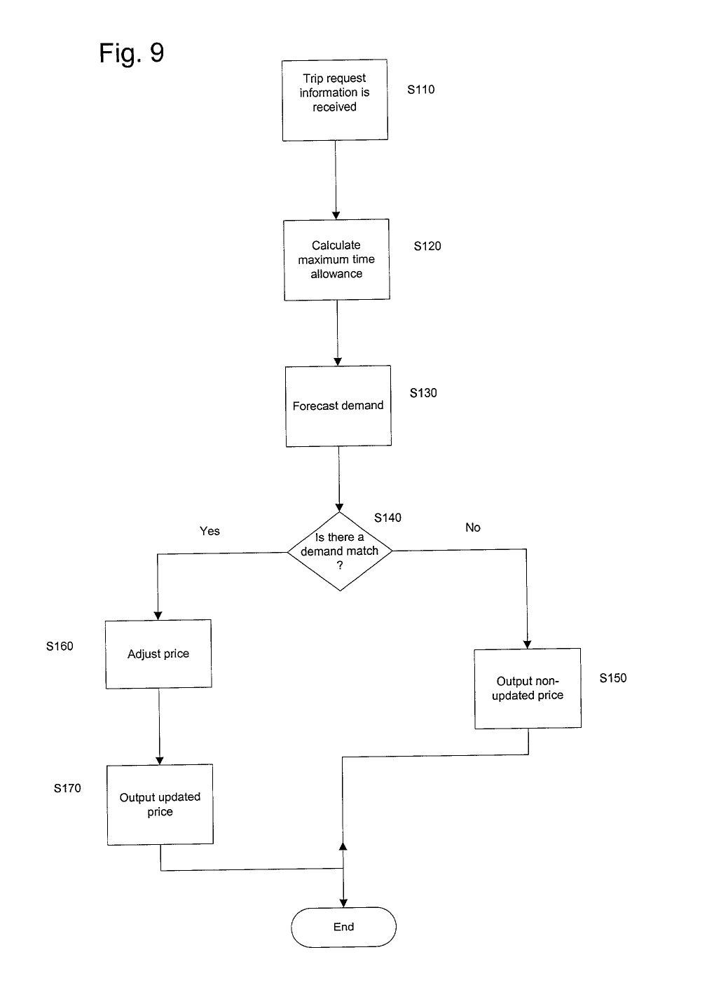

FIG. 9 shows the process for dynamically pricing air-charter services according to an embodiment of the invention. The process begins with step S110 whereby trip request information is received. The trip request information includes origin information, destination information, aircraft type information time schedule information and the number of passengers. Each of these trip request information components are important factors for dynamically determining the price for air charter services.

The process then moves to step S120. In step S120, the system calculates the maximal time allowance t. The waiting schedule refers to the amount of time that an aircraft may be waiting on the ground between flights. The maximal time allowance is the maximum amount of time that a given aircraft may remain on the ground without impacting the ability to provide a lower price to customers on any given leg of travel who are using that aircraft. Using the notations described above, the maximal time allowance t* is calculated as follows:

t*=argmax_{t>t1(B)}{c_{T}(t)<c_{T}}

where c_{T} represents the total cost of both legs of the combined trip and where

c_{T}=C(I^{α}₁)+C(I^{α}₂)

The process then moves to step S130. In step S130, the system forecasts the demand for empty seats and/or return flights. The demand forecast is accomplished utilizing a statistical analysis of historical demand. For example, the system will predict the need for a return flight from Chicago to Washington, D.C. on a given date based upon past flight patterns. The process then moves to step S140.

In step S140, the system determines whether there is a demand match based upon the trip request information, the maximal time allowance t* and the demand forecast. A demand match means that either an aircraft or seats on an aircraft are available on an aircraft already in use. Thus, the cost for using the aircraft is reduced because it is already “in use.” In step S140, if the system determines that there is not a demand match, the process goes to step S150 where there is a output indicating that there is no demand match, and thus, no price update. If in step S140 the system determines that there is a demand match, the process goes to step S160. The process for determining whether there is a demand match is described in greater detail below with reference to FIG. 6.

In step S160, the system generates a price discount based upon the demand matching information, along with information related to incentive promotions, targets and competitions The process then goes to step S170.

In step S170 the system outputs updated pricing information based upon the demand matching. The process then ends with step S180.

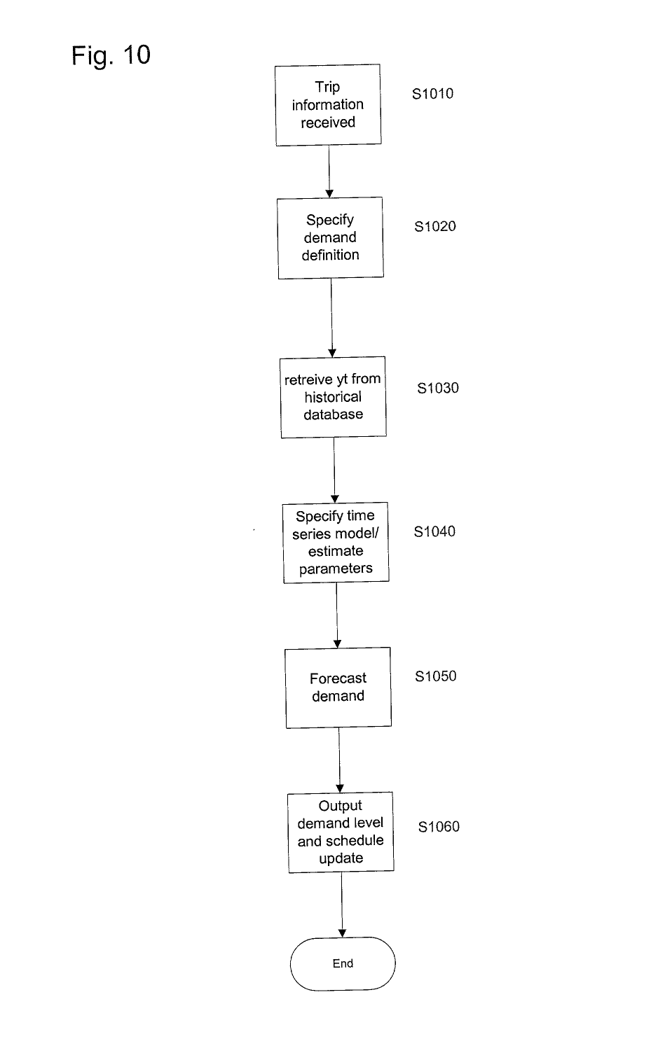

FIG. 10 illustrates the demand forecasting process described above with respect to step S130 of FIG. 9 in greater detail. The demand forecasting (modeling) process analyzes historical demand through a time series modeling techniques. In step 1010, the system receives trip information input, O, D, a and t*, which provides, origin, destination and aircraft type information, all for a given time interval. The process then moves to step S1020.

In step S1020, the demand definition is specified, i.e., whole carrier or single traveler concept. The system is capable of handling different demand definitions depending upon the application. For example, the system supports a single user model where demand is observed for individual travelers based upon their origin, destination and time schedule. Alternatively, a whole charter model includes the aircraft type in addition to itinerary information. The process then moves to step S1030.

In step S1030, the system filters the necessary data from the historical database. In this step a database is created to store the following itinerary fields: trip time schedule, origin destination pairs, aircraft type and number of passengers.

Yₜ may be considered as the number of demand points at a time t. For instance, in the single user model, γₜ can denote the number of passengers flying from Boston to New York for a certain t=Dec. 1, 2000. Similarly, in the whole aircraft charter case, γₜ can denote the number of large aircraft that have flown from Boston to New York for a certain t=Dec. 1, 2000.

The process then moves to step S1040. In step S1040, a time series model is imposed to analyzed the historical demand patterns. An integrated auto-regressive average process ARIMA(p,d,q) is used as the demand model as described below:

φ(B)Δ^{d}γₜ=θ(B)εₜ

where:

φ(B)=1−φB−φ₂B²−. . . −φₚB⁰

θ(B)=1−θB−θ₂B²−. . . −θ_{q}B^{q}

φ(B) is called the auto-regressive operator and the θ(B) as the moving average operator. Δ denotes the difference, i.e., Δyₜ=yₜ₋₁, Δ²yₜ=Δyₜ−Δyₜ₋₁ and so forth. B is the backward shift operator, i.e., Byₜ=yₜ₋₁.

The following iterative method is used to tune the model: first, initialize the model parameters p, d, f; second, estimate the parameters (φ1, . . . φₚ) and (θ₁, . . . , θ_{q}); and third conduct a diagnostic check. The diagnostic check determines whether the original specification is correct or not. At the end of this iterative step, model orders p*, d*, q* and model parameters (φ′₁, . . . , φ′ₚ) and (θ′₁, . . . , θ′_{q}) are calculated. Time series model ARIMA(p*, d*, q*), with parameters (φ′₁, . . . , φ′ₚ) and (θ′₁, . . . , θ′₁) is employed to forecast demand within a certain confidence interval.

The process then moves to step S1050 where the demand is forecasted based upon the methodology of step S1040. The process then moves to step S1060, where the demand forecast is output and the schedule is updated. The process then ends.

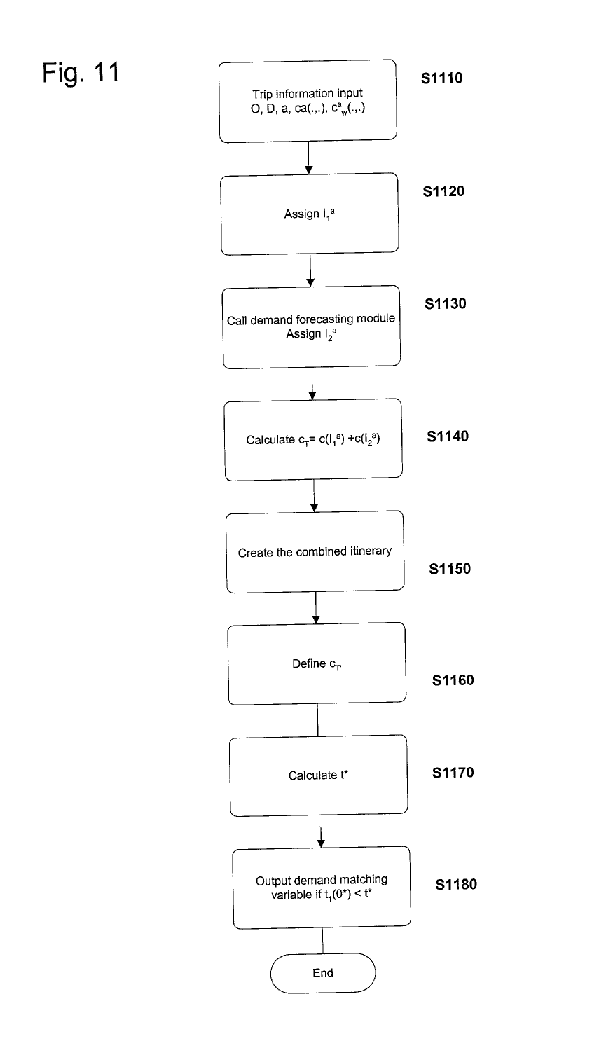

FIG. 11 illustrates the demand matching step S140 of FIG. 9 in greater detail. The demand matching process determines whether the empty or positioning legs can be recycled or utilized within the system. The process begins with step S1110. In step S1110, the trip information is received. For example, a traveler 1 may book a trip from O to D starting at time t₁(O) and ending at t₁(D) with the aircraft class at time to, i.e., to <t₁(O). The process then goes to step S1120.

In step S1120, the system creates an itinerary list I^{α}₁={(O,t₁(O)), (D,t₁(D))}. The process then moves to step S1030.

In step S1130, the system calls the demand forecasting module 230 and creates a fictitious demand having an itinerary I^{a}₂. A fictitious demand from an origin O*∈N_{δ}(D) to D*∈N_{δ}(O) for an un-dominating aircraft class and for a certain δ neighborhood value is forecasted. As a by-product, the traveler 2's trip start date t₁(O*) is also provided. Thus, I^{α}₂={(O*,t₁(O*)), (D*,t₁(D*))}.

The process then moves to step S1130. In step S1140, the system calculates the total flight cost as if the trip requests (original and fictitious) are unrelated, i.e., c_{T}=c(I^{α}₁)+c(I^{α}₂). The process then moves to step S1150. In step S1150, the system creates a combined itinerary, I^{α}_{c}=I^{α}₁ U I^{α}₂, also equal to:

I^{α}_{c}={(O,t₁(O)),(D,t₁(D)),(O*,t₁(O*)), (D*,t₁(D*))}

with an associated waiting list W(I^{α}_{c})={(D,t−t₁(D))}. The process then moves to step 1160.

In step S1160, the system calculates the total flight cost of the combined itinerary, c_{T′}(t)=c(I^{α}_{c}, W(I^{α}_{c})), W(I^{α}_{c})={(D, t−t₁(D))}. The process then moves to step S1170.

In step S1170, the system calculates the maximal time allowance:

t*=argmax_{t>t1(D)}{c_{T}(t)<c_{T}}

The process then moves to step S1180. In step S1180, the system outputs a demand matching assignment if t₁(O*)<t*. The process then ends.

The various demand matching scenarios for round-trips may be listed as follows:

a: The system can find a round trip:

I^{α}={(X,t₁(X)), (Y,t₁(Y)),(Y,t₂(Y)),(X,t₂(X))}

so that t₂(X)≦t₂(D).

In other words, the system is seeking a round trip starting from a neighborhood D, such that the new trip ends before the second leg of I^{α}₁ begins.

b: No round trip matching occurs.

The system can determine a one-way match for the pair {(O,t₁(O)), (D,t₁(D))}. For the second leg {(D,t₁(D)), (O, t₂(0))} the system assigns an aircraft already scheduled to arrive at Y∈N_{δ}D) such that t₁(Y)=t(Y,D)≦t₂(D). The time constraint ensures that the aircraft's time schedule is feasible to pick up the traveler for the second leg.

c: No round-trip matching occurs. The system can determine a one-way trip {(X,t₁(X)), (Y,t₁(Y))} such that t₁(Y)+t(Y,D)≦t₂(D). Preferably, both X and Y are in the area of D, i.e, X, Y∈N_{δ}(D). The time constraint reflects a feasible flight schedule for the aircraft.

d: Case a, b and c, above, do not apply. Thus, the system finds one-way matches for the pairs {(O,t₁(O)), (D,t₁(D))} and {(D,t₂(D)), (O,t₂(O))}.

Step S160 of FIG. 9, related to the dynamic adjustment of prices, is described in greater detail. The dynamic pricing methodology dynamically forecasts and matches demand and allocates excess capacity. The dynamic pricing system also carries out stochastic (probabilistic) demand modeling and a cancellation policy in conjunction with the dynamic pricing.

With regard to cancellation policy, brokerage companies require a customer to actually book a trip by t_{accept} which is requested at t_{request}. In other words, t_{accept} is the latest time that a customer should finalize the booking process. Between t_{request} and t_{accept} the customer can cancel the trip by paying a cancellation fee. In addition, after t_{accept}, the customer is a position to pay any cost associated with the aircraft positioning plus the matching traveler's discount.

For a specified itinerary I^{α}, let cancel(I) be the number of cancelled itineraries. Let total(I) be the total number of trip requests within the category of I. Statistically, p(I)=cancel(I)/total(I) which denotes the frequency or a probability that a cancellation may be expected. The system will store cancellation statistics to calculate p(I) to be used in the dynamic (risk) pricing.

Under the current pricing approach, a brokerage company charges c_{T1}(1+r) and c_{T}(1+r) to travelers 1 and 2, respectively. c_{T}=c_{T1}+c_{T2} is the overall cost of the two trips. A demand match is then predicted with a maximal time allowance t* so that c_{T}(t*)<c_{T}. Further, let ΔC=c_{T}−c_{T′}(t*). The brokerage company will be in a position to distribute ΔC among the participants, i.e., the operator, the brokerage company and the traveler. A cancellation is expected with a probability of p(I), so ΔC is revised so that ΔC=(1−p(I)) ΔC. If γ₁, γ₂ and γ₃ are distribution percentages for the operator, client and brokerage company, so that γ₁+γ₂+γ₃=1, a brokerage company charges a traveler 1 and 2 c_{T1}(1+r)−(1−p(I)) ΔC_{γ1α1} and c_{T2}(1+r)−(1−p(I)) ΔC_{γ2a2}, respectively, for α₁, α₂∈[0,1) so that α₁+α₂=1. The cancellation fee for traveler 1 is (1−p(I)) ΔC_{γ1α1}. If the traveler 1 cancels the trip and the brokerage company does not receive the predicted traveler 2's trip booking by t_{accept} the system automatically ends the process.

Once a brokerage company sets the prices based upon a demand forecast and a cancellation policy, the contract with customer 1 is initiated. The demand forecasting module can claim that there will be a matching demand only with a certain probability p(matching) probability of matching) that depends upon both macro and micro level parameters. Thus, even though p(matching) may be quite high, there is a risk of not having a matching demand that costs the brokerage company (1−p(I)) ΔC_{γ1a1}. Under the case of demand matching, the brokerage company gets an additional profit of (1−p(I))ΔC_{γ3}. Therefore, the expected profit (AP) is: E(AP)=p(matching) (1−p(I))ΔC_{γ3}−(1−p(matching))(1−p(I))ΔC_{γ1a1}.

The single traveler plan described earlier is now described in greater detail. In general, there is a large number of excess seat capacity on booked flights, empty legs or positioning flights. This excess capacity goes unused because of the lack of effective matching services that match the supply of excessive air charter capacity with demand.

According to one embodiment of the invention, the invention provides a system and method allowing travelers to book private charter aircraft and then share available seats on that flight with other interested travelers.

In this embodiment, a traveler first books a charter flight. Next, if there is excess capacity, the system recycles the excess seats into a brokerage company database. If a second traveler requests a trip that has a similar routing and a similar itinerary, the system offers the excess capacity to the second traveler.

It will be apparent to those skilled in the art that various modifications and variations can be made in the invention without departing from the spirit or scope of the invention. Thus, it is intended that the present invention covers the modifications and variations of this invention provided that they come within the scope of any claims and their equivalents.

1. A method for dynamically setting probabilistic prices for aircraft charter services comprising the steps of:
receiving trip request information;
determining a maximal time allowance;
forecasting demand based upon demand models;
matching demand based upon the received trip request information, the maximal time allowance and the forecasted demand;
determining a price discount; and
outputting an adjusted sale price based upon the price discount.

2. The method according to claim 1, wherein the maximal time allowance:
t*=argmax_{t>t1(D)} {c_{T′}(t)<c_{T}}
where t=a time that an aircraft is waiting at a location D;
t₁(D)=an arrival time for the aircraft at the location D;
c_{T′}(t)=a total cost with the aircraft staying at the location D until the time t; and
c_{T}=a total cost for a conventional flight plan.

3. The method according to claim 1, wherein the price discount is based upon a cancellation policy.

4. The method according to claim 1, wherein the step of forecasting the demand includes:
receiving trip information;
specifying a demand definition based upon the trip information;
retrieving relevant data yₜ from a historical demand database;
specifying a time series model based upon yₜ;
estimating parameters of the time series model; and
applying the time series model with the estimated parameters to forecast demand.

5. The method according to claim 4, wherein the demand definition is one of a single traveler with an associated itinerary and a whole aircraft with an associated itinerary and an aircraft type.

6. The method according to claim 4, wherein the step of determining yₜ from a historical demand database includes creating a database, storing a trip time schedule, origin destination pairs, aircraft type information and the number of passengers.

7. The method according to claim 4, wherein the step of estimating parameters includes:
initializing model parameters p, d, and f;
estimating parameters (φ′₁, . . . , φ′ₚ) and (θ′₁, . . . , θ′_{q}); and
conducting a diagnostic test.

8. The method according to claim 1, wherein the step of matching demand includes:
receiving trip information;
creating an itinerary list;
generating a fictitious demand element within a certain probability interval;
calculating a flight cost c_{T};
creating a combined itinerary;
calculating a total flight cost c_{T′} for the combined itinerary;
calculating a maximal time allowance t*; and
outputting a demand matching assignment if t₁(O*)<t*.

9. The method according to claim 8, wherein the step of generating a fictitious element includes calling the demand module.

10. A system for dynamically determining the price of aircraft charter services, comprising:
a programmed computer;
a storage device, accessible by the programmed computer, for storing trip request information;
a demand forecasting module; and
a demand matching pricing module.

11. The system according to claim 10, wherein the demand forecasting module includes a statistical analysis module and a historical demand database.

12. The system according to claim 10, wherein the demand forecasting module receives trip information, specifies a demand definition based upon the trip information, retrieves relevant data yₜ from a historical demand database, specifies a time series model based upon yₜ, estimates parameters of the time series model, and applies the time series model with the estimated parameters to forecast demand.

13. The system according to claim 10, wherein the demand definition is one of a single traveler with an associated itinerary and a whole aircraft with an associated itinerary and an aircraft type.

14. The system according to claim 10, wherein the demand matching module receive trip information, creates an itinerary list, generates a fictitious demand element within a certain probability interval, calculates a flight cost, creates a combined itinerary, calculates a maximal time allowance, and outputs a demand matching assignment if t₁(O*)<t*.

15. The system for dynamically determining the price of aircraft charter services according to claim 10, wherein the trip request information includes at least one of origin information, destination information, aircraft type information, time schedule information and a number of passengers.
